(19) United States
(12) Patent Application Publication
(10) Pub. No.: US 2009/0276321 A1
(43) Pub. Date: Nov. 5, 2009

(54) METHOD AND SYSTEM FOR AUTOMATED PAYMENT AUTHORIZATION AND SETTLEMENT

(76) Inventors: Shari L. Krikorian, Armonk, NY (US); Philip J. Philliou, Haworth, NJ (US); Edward F. Downs, River Vale, NJ (US)

Correspondence Address: BAKER BOTTS L.L.P., 30 ROCKEFELLER PLAZA, 44TH FLOOR, NEW YORK, NY, 10112-4498, US

(21) Appl. No.: 12/501,297

(22) Filed: Jul. 10, 2009

Related U.S. Application Data
(63) Continuation of application No. 11/676,860, filed on Feb. 20, 2007.
Application No. 11/676,860 is a continuation of application No. PCT/US05/30384, filed on Aug. 25, 2005.
(60) Provisional application No. 60/604,215, filed on Aug. 25, 2004.
(60) Provisional application No. 60/623,656, filed on Oct. 29, 2004.

(51) Int. Cl. G06Q 20/00; G06Q 10/00; G06Q 30/00; G06Q 40/00

(52) U.S. Cl. 705/17; 705/34

(57) ABSTRACT

The present invention provides a system and method to enable a third party service provider of EIPP services to initiate authorization and settlement of payment card payments with invoice line item data (Level III data), on behalf of either Buyer/Payers or Supplier/Payees to credit card acquirers and/or transaction processors. Payment initiation is based on submission of either a pre-approved invoice or order confirmation validated against a purchase order, or an invoice approved by the Buyer/Payer organization and scheduled for payment.

### CROSS-REFERENCE TO RELATED APPLICATION

This application is a continuation of U.S. application Ser. No. 11/676,860, filed Feb. 20, 2007, which is a continuation of International Application PCT/US05/030384, filed Aug. 25, 2005, which claims priority to U.S. Provisional Application No. 60/604,215, filed Aug. 25, 2004 and U.S. Provisional Application No. 60/623,656, filed Oct. 29, 2004, each of which is incorporated by reference in its entirety herein, and from which priority is claimed.

### BACKGROUND OF INVENTION

This invention relates to a method and system for automated payment authorization and settlement.

Attempts have been made to automate the invoicing and payment process through the use of third-party service providers (“3PSPs”). 3PSPs include electronic procurement providers such as Ariba™, electronic invoice presentment and payment (“EIPP”) providers such as Xign™, and enterprise resource planning (“ERP”) providers such as Oracle™. These early 3PSP solutions focused on the needs of the Supplier/Payee/biller and did not adequately address the needs of the Buyer/Payer/payer. For example, many early 3PSP solutions did not address the payment-related needs of the Buyer/Payer/payer, such as to efficiently and effectively control the initiation of payments, defer their settlement, and reconcile and integrate them into the Buyer/Payer's financial systems.

Furthermore, existing 3PSP solutions have not typically utilized payment cards, such as credit cards, debit cards, corporate cards, or purchasing cards, as a means of business-to-business payments. Moreover, these 3PSP solutions have not allowed the use of payment terms associated with payment by payment cards or the validation of Buyer/Payer invoicing rules prior to payment by payment card.

Furthermore, existing 3PSP solutions are not capable of automated integration of payment card data into an organization's internal systems, such as its ERP or accounts payable (“A/P”) systems. Accordingly, organizations are forced to manually re-key invoice data, match it with the card transaction for reconciliation purposes, and then manually enter the data into the organization's ERP or A/P system. This process is time consuming and prone to human error.

Some existing 3PSP solutions may utilize financial electronic data interchange (“EDI”) or other electronic payment technologies. However, these payment methods may require significant set-up costs, including costly changes to internal systems and processes, and may require changes in banking relationships.

There therefore exists a need for an automated EIPP method and system that is cost-effective, simple to integrate into existing processes and systems, and allows for efficient payment and reconciliation of financial records.

In U.S. patent application Ser. No. 10/465,394, MasterCard presented a system and method of automated electronic invoice presentment and payment that utilized a purchasing card as a possible method of payment. The present invention improves on that prior application. According to the present invention, 3PSPs that provide electronic procurement and/or invoicing can now allow their customers to settle transactions automatically on a MasterCard credit card account, thereby allowing their customers to make purchase order (“PO”) or invoice-based purchases on bank credit terms. Payers benefit from delayed payment terms and opportunity to receive volume rebates from issuing banks. Suppliers benefit from electronic payment receipt (as compared to the costs of processing checks) and the opportunity to pass Level III data (to receive lower discount rate) without additional investment in hardware or software. Financial institutions and their processors benefit from the greater volumes of transactions processed. Examples of acquiring institutions and transaction processors are Citibank, First Data Corporation, Global Payments, and Bank of America.

### SUMMARY OF THE INVENTION

The present invention provides a system and method to enable a 3PSP to initiate authorization and settlement of payment card payments with invoice line item data (Level III data), on behalf of Buyer/Payers/payers or Supplier/Payee/payees to credit card acquirers and/or transaction processors. Payment initiation is based on submission of either: a pre-approved invoice or order confirmation validated against a purchase order, or an invoice approved by the Buyer/Payer/payer organization and scheduled for payment.

### BRIEF DESCRIPTION OF THE DRAWINGS

FIG. 1 is a block diagram illustrating an exemplary system for automated payment authorization and settlement of payment card transactions, in which payment is initiated by the payer;

FIG. 2 is a flowchart illustrating an exemplary method for automated payment authorization and settlement of payment card transactions, in which payment is initiated by the payer;

FIG. 3 is a block diagram illustrating an exemplary system for automated payment authorization and settlement of payment card transactions, in which payment is initiated by the payee;

FIG. 4 is a flowchart illustrating an exemplary method for automated payment authorization and settlement of payment card transactions, in which payment is initiated by the payee;

FIG. 5 is a flowchart illustrating immediate settlement of a purchase order initiated purchasing card transaction in accordance with an exemplary embodiment of the present invention;

FIG. 6 is a flowchart illustrating delayed settlement of a purchase order (“PO”) initiated purchasing card transaction in accordance with an exemplary embodiment of the present invention;

FIG. 7 is a flowchart illustrating delayed settlement of a non-PO purchasing card transaction, in accordance with an exemplary embodiment of the present invention;

FIG. 8 is a flowchart illustrating an exemplary process of MS gateway authorization and settlement in accordance with the present invention; and

FIG. 9 is a flowchart illustrating an exemplary process of handling MS authorization failure in accordance with the present invention.

### DETAILED DESCRIPTION OF THE INVENTION

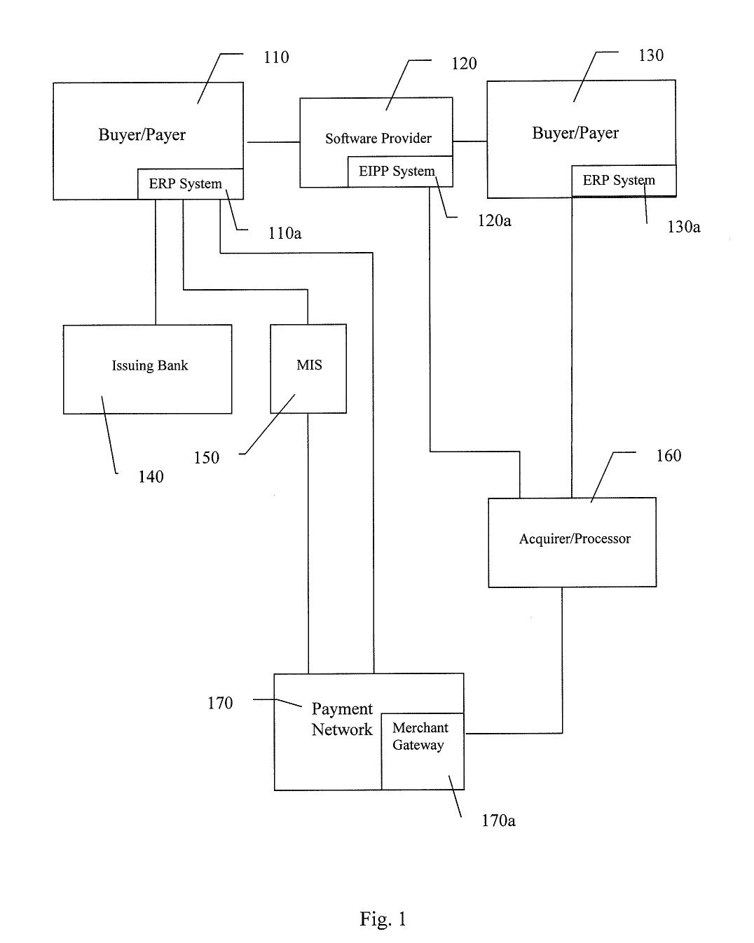

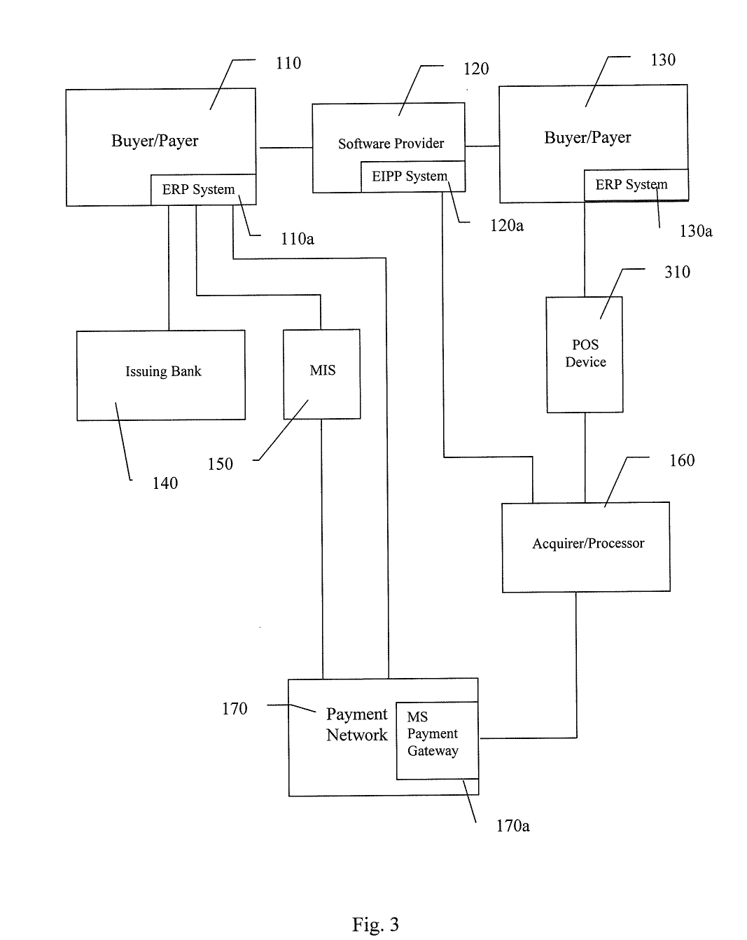

FIGS. 1 and 3 are block diagrams that illustrate exemplary systems for automated payment authorization and settlement of payment card transactions. In the exemplary embodiment depicted in FIG. 1, payment is initiated by the payer, whereas in the exemplary embodiment depicted in FIG. 3, payment is initiated by the payee. Referring to FIGS. 1 and 3, a Buyer/Payer 110 is the party buying a product or service from a Supplier/Payee 130. Each of Buyer/Payer 110 and Supplier/Payee 130 preferably includes an ERP system 110a and 130a respectively. A Software Provider 120 is a 3PSP providing electronic procurement, invoicing, presentment and/or payment services, such as, for example, an EIPP system 120a. For example, the Software Provider 120 could be Xign Corporation™ providing a MasterCard e-P3™ EIPP solution.

An Acquirer/Processor 160 is a financial institution or a transaction processor that processes payment card transactions. A Payment Network 170 is a payment card network, such as the MasterCard™ payment network. A merchant services (“MS”) payment gateway 170a is a gateway through which authorization and settlement for payment card transactions are preferably processed. An Issuing Bank 140 is a bank that issues a payment card to the Buyer/Payer 110. An MIS 150 is the Issuing Bank's 140 management information system. A POS device 310 in FIG. 3 is a point of sale terminal, or any similar conventional system, that accepts financial data at or near the Supplier/Payee's 130 location, and transmits that data to a payment network for reporting activity, authorization, and transaction logging.

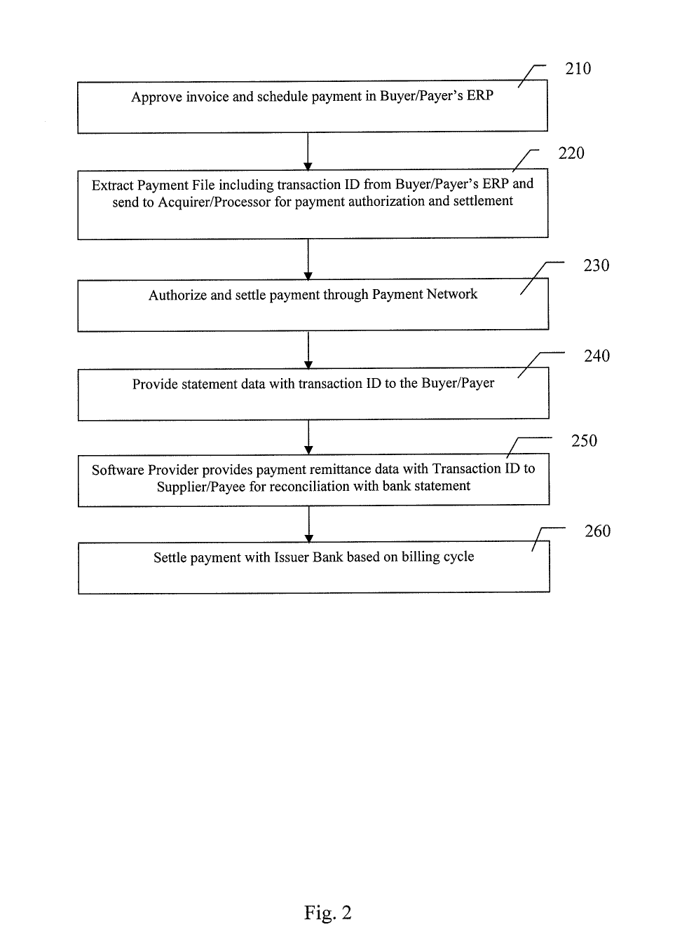

FIG. 2 is a flowchart that illustrates an exemplary method for automated payment authorization and settlement of payment card transactions, where the payment is initiated by the Buyer/Payer 110. Referring to FIGS. 1 and 2, at step 210 the Buyer/Payer's ERP 110a approves and schedules payment for an invoice. In this embodiment, the Buyer/Payer's ERP 110a may be, for example, an Oracle payables system. At step 220, the Software Provider 120 extracts a payment file from the Buyer/Payer's ERP 110a and sends the payment file to the Acquirer/Processor 160 for payment authorization and settlement. For example, the payment file may be extracted from the Buyer/Payer's 110a Oracle Payables financial system by Oracle iPayment™, a MasterCard e-P3™ provider.

The payment file includes a merchant ID, payment card account information, a unique transaction ID used for ERP invoice reconciliation, and may contain invoice line item data (Level III data). The Merchant ID may be acquired during a process of enrolling the Supplier/Payee 130. The Software Provider 120—such as Oracle iPayment™—may obtain payment card account information from either the Buyer/Payer's ERP 110a—e.g., Oracle Payables—or from the Software Provider's 120 payment interface 120a.

At step 230, the Buyer/Payer's 110 payment card payment requests are submitted to the Payment Network 170—such as, for example, MasterCard's payment network—for authorization and settlement. At step 240, payment card statement data is provided to the Buyer/Payer 110 via either the Issuing Bank's MIS application 150 or directly from the payment network 170. The payment card statement data preferably includes the unique transaction ID from the payment file (see Step 220).

At step 250, the Software Provider 120 provides payment remittance data, including the unique transaction ID, to the Supplier/Payee 130 for reconciliation with the bank statement provided by the Acquirer/Processor 160. For example, payment remittance data may be provided to the Supplier/Payee 130 by an e-P3™ provider such as Oracle iPayment™ for reconciliation with its bank statement. Finally at step 260, the Buyer/Payer 110 settles the payment card transactions with the Issuing Bank 140 at the end of the billing cycle.

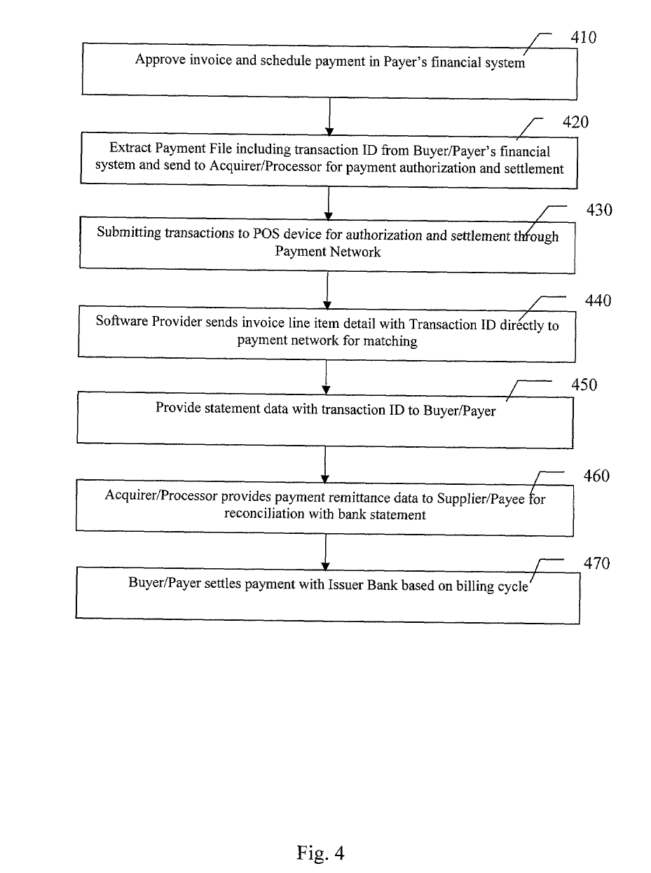

FIG. 4 is a flowchart that illustrates an exemplary method for automated payment authorization and settlement of payment card transactions, where the payment is initiated by the Supplier/Payee 130. Referring to FIGS. 3 and 4, at step 410 the Buyer/Payer's ERP 110a approves and schedules payment for an invoice. At step 420, the Software Provider 120 extracts a payment file from the Buyer/Payer's ERP system 110a and transmits (e.g., by e-mail) the payment file to the Supplier/Payee 130 for payment authorization and settlement. The payment file includes a merchant ID, payment card account information, a unique transaction ID used for ERP invoice reconciliation, and may contain invoice line item data (Level III data). The Merchant ID is acquired during a process of enrolling the Supplier/Payee 130. The Software Provider 120 obtains payment card account information from either the Buyer/Payer's ERP 110a, or from the Software Provider's payment interface 120a.

At step 430, the Supplier/Payee 130 submits payment card and other transaction information to the Acquirer/Processor 160 via a POS device 310 for the purposes of authorization and settlement. The Acquirer/Processor routes the authorization and settlement information through the payment network 170. At step 440, the Software Provider 120 sends invoice line item data, including the unique transaction ID, directly to the payment network 170 for matching purposes.

At step 450, the payment card statement data is provided to the Buyer/Payer 110 via either the Issuing Bank's MIS application 150 or directly from the payment network 170. The payment card statement data preferably includes the unique transaction ID from the payment file (see Step 420). At step 460, payment remittance data is provided to the Supplier/Payee 130 by the Acquirer/Processor 160 for reconciliation purposes. Finally, at step 470 the Buyer/Payer 110 settles the payment card transactions with the Issuing Bank 140 at the end of the billing cycle.

Additional exemplary embodiments of the present invention will now be described. Although these exemplary embodiments refer to the use of a purchasing card, such as MasterCard's P-Card™, any payment card may be used as an alternative. The present invention assists both the Software Provider 120 providing the EIPP platform 120a and the Acquirer/Processor 160 in building functionality for automating and integrating Supplier/Payee 130 enrollment, payment authorization and/or settlement requests and responses, and exception workflow notifications.

In the exemplary embodiments described herein, a merchant services (“MS”) payment gateway 170a (FIGS. 1 and 3) is preferably employed. The MS gateway 170a is the gateway through which authorization and settlement for purchasing card transactions are preferably processed. This processing is may be fulfilled in batch mode, wherein Level III transactions are accumulated and sent at periodic intervals to the MS gateway 170a in a standard data interchange format, for example, the 810 EDI format. The MS gateway 170a preferably splits the transactions based on a merchant identifier (“Merchant ID”) in order to route the transactions to the appropriate locations. The MS gateway 170a preferably provides an authorization response back in a standard data interchange format, such as, for example, the 824 EDI format. For those transactions that have authorized, the MS payment gateway 170a preferably proceeds with the settlement processing with Level III data that has been provided.

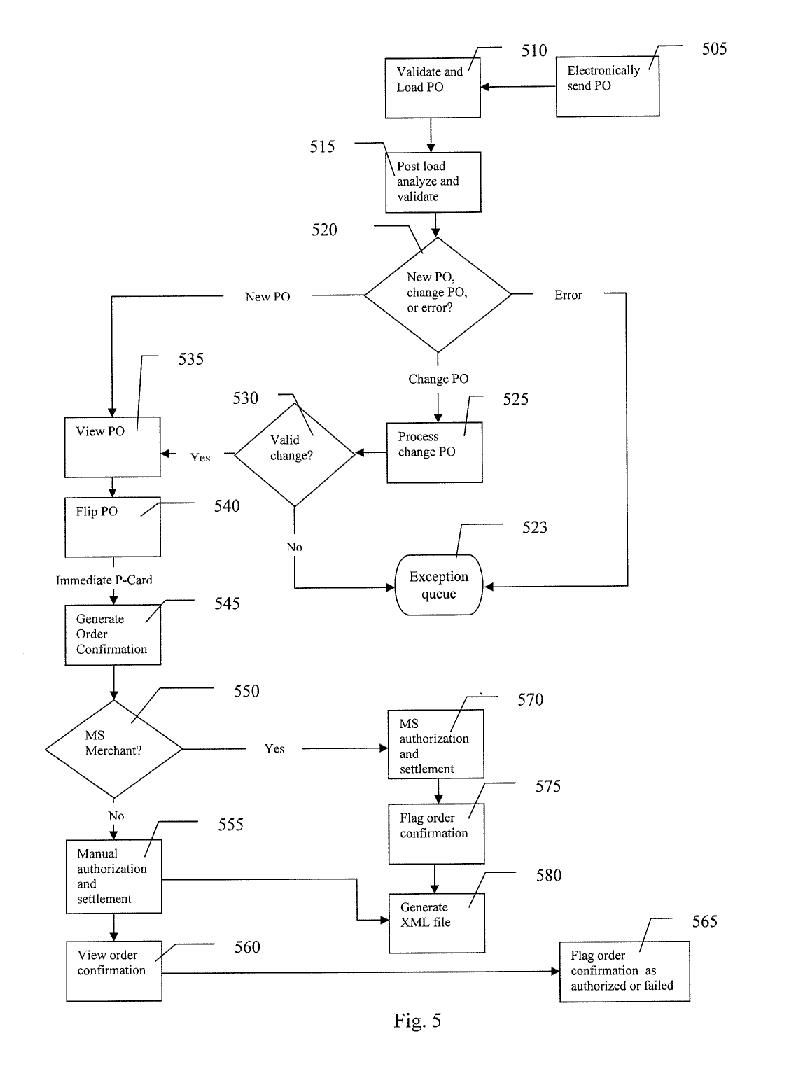

FIG. 5 is a flowchart depicting immediate settlement of a purchase order (“PO”) initiated purchasing card transaction in accordance with an exemplary embodiment of the present invention. At step 505, Buyer/Payer 110 electronically sends a PO from its ERP system 110a to the Software Provider's EIPP system 120a. At step 510, once the PO file has been sent to the EIPP system 120a in the required format, the PO Load process is invoked to transform, parse and load the POs into the EIPP system 120a.

At step 515, once the POs have been loaded into the EIPP system 120a and validated for format and structure, the EIPP system 120a initiates a post-load analysis of the PO. The post load analysis includes a series of basic validations such as (i) determining whether information about the Supplier/Payee 130 and the Buyer/Payer 110 is available in the PO header; (ii) determining and validating the purchasing card information that is provided as the payment method; (iii) determining if it is a new PO, a duplicate PO, or a change PO and flagging it appropriately for further processing; and (iv) determining the payment terms, i.e., if it is an immediate or delayed PO.

At step 520, after the post load PO analysis has been completed, it is preferably decided whether the PO should be flagged as a new PO or change PO for further processing. In case of an exception, the PO is flagged as an error along with the appropriate reason and dispatched to the exception queue at step 523. At step 525, if the PO has been flagged as a change PO, the EIPP system 120a initiates the “change PO” processing. Depending on whether the original PO has been fulfilled and based on the rules defined for the relationship between the Buyer/Payer 110 and the Supplier/Payee 130, the system proceeds to apply the change to the PO and generates a PO history.

In the case of a change PO, once the appropriate processing has been completed at step 525, it is preferably decided at step 530 whether the change was a valid one. If the change was not valid, the PO is flagged as an error and dispatched to the exception queue at step 523. If the change was valid, the PO is routed to one or more agents of the Supplier/Payee 130 using the Supplier/Payee 130 setup information and/or details of a Vendor ID/Customer account number that are obtained from the PO. An e-mail notification is preferably send to the Supplier/Payee 130 to inform about the PO.

At step 535, the agent of the Supplier/Payee 130 can preferably view a summary of all POs that have been routed to it. If the PO has a purchasing account number associated with it, then the summary line for that PO will preferably indicate that such is the case. Also the summary line for the PO will indicate whether the payment terms are immediate. The Supplier/Payee's 130 agent could choose to view the details of the PO. The PO detail view may then be presented. Masked purchasing card information may also be available in the PO detail view.

At step 540, from the PO summary or the PO detail view, the Supplier/Payee's 130 agent may flip the PO. The agent is presented with an editable interface (as defined by the Buyer/Payer 110) of the PO details. At this stage too the purchasing card number remains masked. The Supplier/Payee's 130 agent selects the elements that are to be included in the order confirmation along with quantity. When the Supplier/Payee's 130 agent proceeds to perform the flip (partial or full), the system generates a draft order confirmation. The draft order confirmation has editable fields for Tax and FOB that are prepopulated with values if available with the PO. The Supplier/Payee's 130 agent may override these elements, and may also override the generated invoice number and proceed to generate the order confirmation.

At step 545, the status of the PO changes to “processing payment” and the EIPP 120a generates and associates a unique number with the order confirmation. At step 550, based on whether the Supplier/Payee 130 has been acquired by the MS gateway, the appropriate payment-related processes are initiated. At step 555, if the Supplier/Payee 130 has not been acquired by the MS gateway 170a, the order confirmation view that is presented to the Supplier/Payee 130 would have an option to initiate manual payment authorization processing.

At step 560, on selecting the manual option, the Supplier/Payee 130 is provided with a view of the order confirmation that has editable fields for entering the authorization code and the date of transaction (pre-populated with the system date). The unique number may also be presented on this screen. At this stage, the purchasing card number may be unmasked. The Supplier/Payee 130 authorizes through an external POS device 310 and enters the unique number in the POS device 310 when prompted, for example, for a customer code.

At step 565, if authorized, the Supplier/Payee 130 updates the order confirmation with the authorization code and the date of the transaction and proceeds to flag the order confirmation as “paid.” If the payment authorization is rejected or fails, both the Buyer/Payer 110 and the Supplier/Payee 130 are notified of this via e-mail, and the invoice is flagged as “failed” and placed in a “Failed Authorizations” summary view or basket.

If, at step 550, the Supplier/Payer 130 has been acquired by the MS gateway 170a, then the EIPP system 120a proceeds at step 570 with the MS gateway authorization and settlement process. The MS gateway authorization and settlement process (step 570) is preferably a batch process by which an authorization/settlement file is generated by the EIPP system 120a and is sent to the MS gateway 170a. The file contains Level III settlement data. At step 575, the EIPP system 120a receives the response from the MS gateway 170a containing the authorization code and proceeds with flagging the order confirmation as being authorized, i.e., as “paid,” and associating the authorization code with the order confirmation. If payment authorization is rejected or fails, both the Buyer/Payer 110 and the Supplier/Payee 130 are notified via e-mail, and the invoice is flagged and placed in the “Failed Authorizations” summary view or basket. For MS-based authorizations, transactions preferably include the appropriate reason code.

The Supplier/Payee 130 may also have the option of viewing the different order confirmations that are generated at a summary level and to select to view a particular order confirmation in detail. There could be certain order confirmations in which the Supplier/Payee 130a (non-MS) may have chosen not to take any action following the flip. These would be flagged as “Awaiting Manual Authorization.”

At step 580, once the order confirmation is flagged as being “Paid,” the related information may be marked in a particular XML schema and appended to the EIPP's 120a XML file that may be exported. Meanwhile, the order confirmation is also routed to the Buyer/Payer 110 based on the routing rules defined in the EIPP 120a. There is preferably an indicator alongside the Invoice/Order confirmation summary line item that indicates that the document is an order confirmation. The Buyer/Payer 110 may view the order confirmation details along with purchasing card details (the purchasing card details masked but for the last four digits of the account number). The Buyer/Payer 110 preferably does no further processing on the order confirmation except to export it to integrate with the accounts payable system.

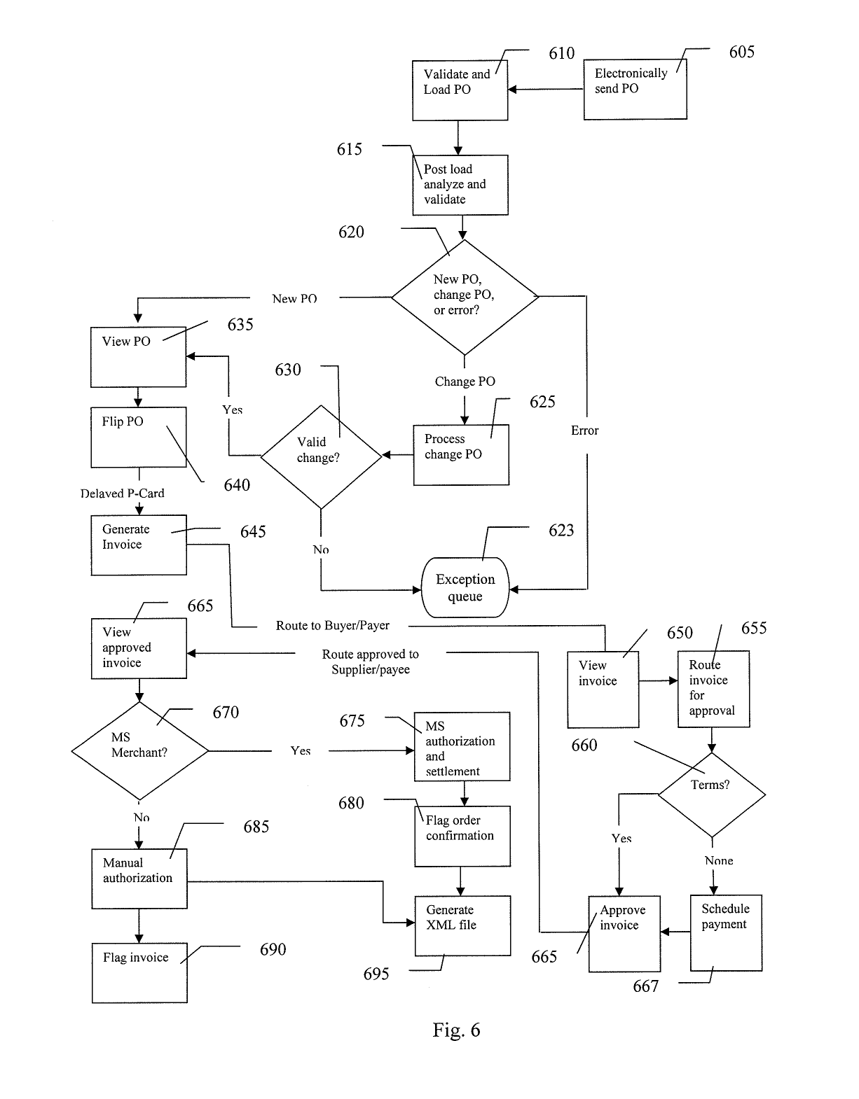

FIG. 6 is a flowchart depicting delayed settlement of a PO-initiated purchasing card transaction, in accordance with an exemplary embodiment of the present invention. At step 605, Buyer/Payer 110 electronically sends a PO from its ERP 120a to the Software Provider's EIPP system 120a. At step 610, once the PO file has been sent to the EIPP 120a in the required format, the PO Load process is invoked to transform, parse and load the POs into the EIPP system 120a.

At step 615, once the POs have been loaded into the EIPP system 120a and validated for format and structure, the EIPP 120a initiates a post-load analysis of the PO. The post-load analysis includes a series of basic validations such as (i) determining whether information about the Supplier/Payee 130 and the Buyer/Payer 110 is available in the PO header; (ii) determining and validating the purchasing card information that is provided as the payment method; (iii) determining if it is a new PO, a duplicate PO, or a change PO and flagging it appropriately for further processing; and (iv) determining the payment terms, i.e., if it is an immediate or delayed PO. In the present exemplary embodiment, a delayed PO may have payment terms such as, for example, “net 15,” “net 30,” etc. There could also be no payment terms at all, which would preferably be considered a special case of a delayed PO.

At step 620, after the post-load PO analysis has been completed, it is preferably decided whether the PO should be flagged as a new PO or change PO for further processing. In case of an exception, the PO is flagged as an error along with the appropriate reason and dispatched to the exception queue 623. At step 625, if the PO has been flagged as a change PO, the EIPP 120a initiates the change PO processing. Depending on whether the original PO has been fulfilled and based on the rules defined for the relationship between the Buyer/Payer 110 and the Supplier/Payee 130, the system 120a proceeds to apply the change to the PO and generates a PO history. In the case of a change PO, once the appropriate processing has been completed at step 625, it is preferably decided at step 630 whether the change was a valid one. If the change was not valid, the PO is flagged as an error and dispatched to the exception queue 623. If the change was valid, the PO is earmarked for or routed to one or more agents of the Supplier/Payee 130 using the Supplier/Payee 130 setup information or Vendor ID/Customer account number details preferably obtained from the PO. An email notification is preferably send to the Supplier/Payee 130 to inform it about the PO.

At step 635, the agent of the Supplier/Payee 130 can preferably view a summary of all POs that have been routed to it. If the PO has a purchasing account number associated with it, then the summary line for that PO will preferably indicate that such is the case. Also the summary line for the PO will indicate whether the payment terms are immediate. The Supplier/Payee's 130 agent could choose to view the details of the PO. The PO detail view may then be presented. Masked purchasing card information may also be available in the PO detail view.

At step 640, from the PO summary or the PO detail view, the Supplier/Payee's 130 agent can choose to flip the PO. The agent is presented with an editable interface (as defined by the Buyer/Payer 110) of the PO details. At this stage too the purchasing card number remains masked. The Supplier/Payee's 130 agent selects the elements that are to be included in the invoice along with quantity. When the Supplier/Payee's 130 agent proceeds to perform the flip (partial or full), the EIPP system, at step 645, generates a draft invoice. The draft invoice has editable fields for Tax and FOB that are prepopulated with values if available with the PO. The Supplier/Payee's 130 agent could override these elements and also the generated invoice number and proceed to generate the invoice at step 645.

At step 645, the generated invoice is routed to the appropriate Buyer/Payer's 110 agent for approval and scheduling. Routing is determined by the Buyer/Payer 110 routing setup and by any other related information about the Buyer/Payer's 110 ID and customer account number obtained from the original PO.

At step 650, the Buyer/Payer's 110 agent may view a summary of all invoices that have been routed to the Buyer/Payer's 110 ID. The PO summary preferably indicates using, for example, a special logo, any PO that has a purchasing card transaction associated with it. The Buyer/Payer's 110 agent may select to view an invoice's details. The purchasing card information is also present in this detailed view. The purchasing card number remains masked, except for the last 4 digits.

At step 655, the Buyer/Payer's 110 agent may route the invoice for approval. The Buyer/Payer's 110 agent may approve the invoice and/or forward it to other agents using the workflow defined for the Buyer/Payer's 110 organization. At step 660, a determination is made whether the PO has attached to it any payment terms, and if so, what they are. If the PO has delayed payment terms explicitly present, the generated invoice is scheduled and approved at step 665, based on those terms. For instance, if the payment terms indicate “Net 15,” the invoice is preferably scheduled for payment 15 days from the date it is available for the Buyer/Payer 110 to view. However, if the payment terms are absent, the Buyer/Payer at step 667 may schedule the invoice for approval and payment on a future date. At step 655, once the invoice has been approved, the approved invoice is routed to the Supplier/Payee for viewing at step 665.

At step 670, on reaching the scheduled date, the status of the invoice is changed to “Processing Payment.” A unique number is preferably generated and associated with the invoice. At step 670, based on whether the Supplier/Payee has been acquired by the MS gateway 170a, the appropriate payment-related processes are initiated. If the Supplier/Payee 130 has been acquired by the MS gateway 170a, then the EIPP 120a proceeds at step 675 with the MS gateway 170a authorization and settlement process.

The MS gateway 170a authorization and settlement process is preferably a batch process by which an authorization/settlement file is generated by the EIPP 120a and sent to the MS gateway 170a. The file preferably contains Level III settlement data. The EIPP 120a receives a response from MS gateway 170a containing the authorization code and, at step 680, proceeds with flagging the invoice as authorized, i.e., flagging it as “Paid,” and associating the authorization code with the invoice.

If payment authorization is rejected or fails, both the Buyer/Payer 110 and Supplier/Payee 130 are notified via e-mail, and the invoice is flagged appropriately at step 680, and placed in a “Failed Authorizations” summary view or basket. For MS gateway 170a authorizations, transactions preferably include appropriate reason code.

If at step 670, when the invoice has reached the scheduled date and is in “Processing Payment” status, it is determined that the merchant has not been acquired i.e., it is determined that the Supplier/Payee 130 is flagged as “Awaiting Manual Authorization,” the manual authorization process is triggered at step 685. When the Supplier/Payee 130 views the details of invoices awaiting manual authorization, an option to initiate payment processing is presented to the Supplier/Payee 130. On selecting this option, the Supplier/Payee 130 is provided with a view of the invoice that has editable fields for entering the authorization code and the date of transaction (pre-populated with the system date). The unique number is also presented on this screen. At this stage the purchasing card number is unmasked. The Supplier/Payee 130 authorizes through an external POS device and enters the unique number in the POS when prompted, for example, when prompted for a Customer Code. Once authorized, the Supplier/Payee 130 updates the invoice with the authorization code and the date of transaction and proceeds to flag the invoice as “Paid.”

If payment authorization is rejected or fails, both the Buyer/Payer 110 and Supplier/Payee 130 are notified via e-mail, and the invoice is flagged at step 690 and placed in the “Failed Authorizations” summary view or basket. If payment authorization is successful, at step 690 the invoice is flagged as having been “Paid,” and related information is appended at step 695 to an EIPP XML file for exporting.

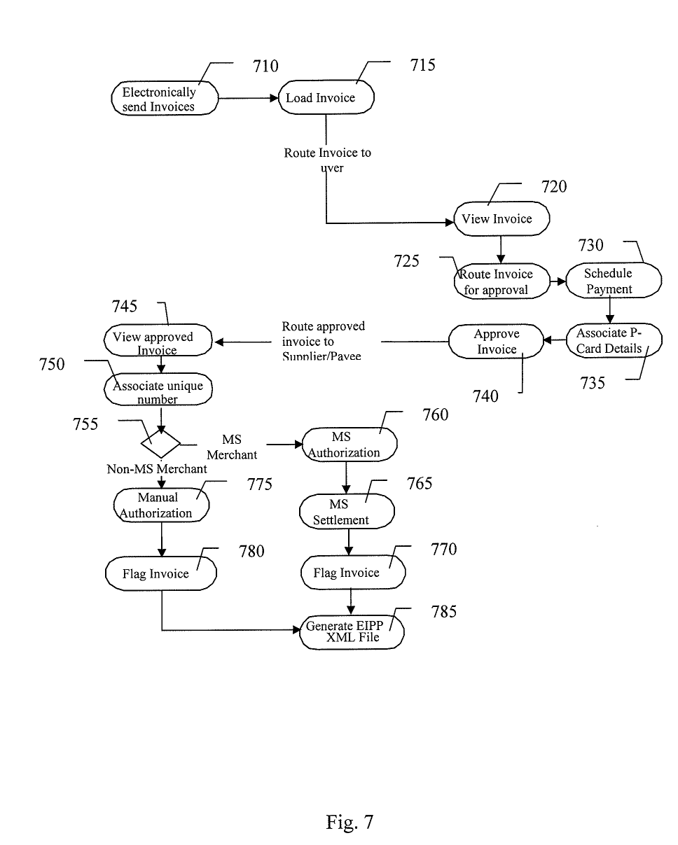

FIG. 7 is a flowchart illustrating delayed settlement of a non-PO purchasing card transaction, in accordance with an exemplary embodiment of the present invention. In this exemplary embodiment, there are no POs that are loaded into the EIPP system 120a. Here, at step 710, the invoices are electronically sent by the Supplier/Payee 130 to the Software Provider 120. At the Software Provider 120, the invoices are loaded, at step 715, into the EIPP 120a. During the invoice load process, the EIPP 120a preferably identifies whether the Supplier/Payee 130 accepts purchasing cards as a payment method. Further, if purchasing cards have been defined as the default payment method for the specific customer account (defined at a Buyer/Payer-Supplier/Payee relationship level), the EIPP system 120a would associate the same to the invoice.

The Buyer/Payer 110 may set up user groups comprising multiple agents who would be authorized to make payments using purchasing cards. The Buyer/Payer's 110 administrator will be able to enter the purchasing card details, such as cardholder name, card number, expiration date, and CVC2 code, and associate the purchasing card with one or more user groups. The Buyer/Payer's 110 administrator could also deem that purchasing cards are to be utilized only for certain specific Supplier/Payees 130.

At step 715, the invoice is loaded and routed to the appropriate Buyer/Payer 110 group based on the routing information available from the invoice. Routing may be done based on the routing ID or customer account number. At step 720, the Buyer/Payer's 10 agent may view a summary of all invoices that have been routed to its ID. At step 725, the Buyer/Payer's 110 agent may approve the invoice and/or forward it to other agents using the workflow defined for the Buyer/Payer's 110 organization. The Buyer/Payer's 110 agent may select the payment method as “purchasing card,” or “purchasing card” may have already been previously defined as the default payment method for the specific customer account, in which case the EIPP system 120a would have already associated purchasing cards to the invoice.

At step 730, once “purchasing card” is established as the payment option, the invoice is automatically scheduled for payment on a future date, or manually scheduled by a Buyer/Payer's 110 agent having “scheduler” privileges. At step 735, the purchasing card details are automatically associated with the invoice. At step 740, the invoice is approved for payment and routed to the Supplier/Payee 130 for viewing at step 745.

At step 750, on reaching the scheduled date, the status of the invoice is changed to “Processing Payment,” and a unique transaction number is generated and associated with the invoice. At step 755, based on whether the Supplier/Payee 130 has been acquired by the MS gateway 170a, the appropriate payment-related processes are initiated. At steps 760 and 765, if the Supplier/Payee 130 has been acquired by the MS gateway 170a, then the EIPP 120a proceeds with the MS gateway authorization and settlement process. MS gateway authorization and settlement is preferably a batch process by which an authorization/settlement file is generated by the EIPP system 120a and sent to the MS gateway 170a. The authorization/settlement file preferably contains Level III settlement data.

At step 770, the EIPP system 120a receives a response from the MS gateway 170a containing the authorization code and proceeds with flagging the invoice as being authorized (Paid) and associating the authorization code with the invoice. If payment authorization is rejected/fails, both the Buyer/Payer 110 and the Supplier/Payee 130 are notified via email, and the invoice is flagged and placed in ‘Failed Authorizations’ summary view/basket. For MS gateway 170a authorizations, transactions will include appropriate reason code.

If at step 755 it is determined that the merchant has not been acquired, i.e., it is determined that the Supplier/Payee 130 is flagged as “Awaiting Manual Authorization,” the manual authorization process is triggered at step 775. When the Supplier/Payee 130 views the details of such invoices (“Awaiting Manual Authorization”), an option to initiate payment processing is presented to the Supplier/Payee 130. On selecting this option, the Supplier/Payee 130 may be provided with a view of the invoice that has editable fields for entering the authorization code and the date of transaction (pre-populated with the system date). The unique number is also presented on this screen. At this point the purchasing card number is preferably unmasked. The Supplier/Payee 130 authorizes through an external POS device 310 and enters the unique number in the POS device 310 when prompted, for example, for the customer code.

At step 780, once authorized, the Supplier/Payee 130 updates the invoice with the authorization code and the date of transaction and proceeds to flag the invoice as “Paid.” At step 780, if payment authorization is rejected/fails, both Buyer/Payer 110 and Supplier/Payee 130 are notified via e-mail, and the invoice is flagged and placed in ‘Failed Authorizations’ summary view/basket. At step 785, once the invoice is flagged as being “Paid”, the related information is marked and appended to the EIPP's 120a XML file for exporting.

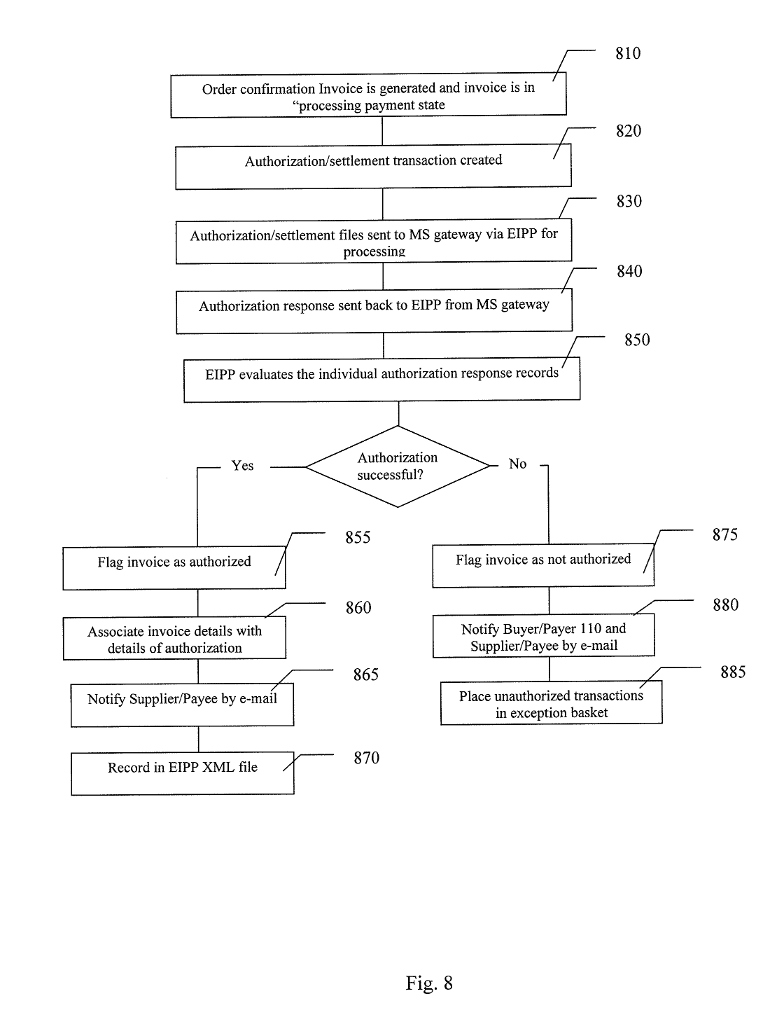

MS authorization and settlement will now be described in greater detail in conjunction with FIG. 8, which is a flowchart illustrating an exemplary process of MS gateway authorization and settlement in accordance with the present invention. MS authorization and settlement is preferably a combined batch process, although it need not be: both authorization and settlement could alternatively be separate processes. MS authorization and settlement is also preferably a backend process, i.e., the user does not have visibility into the process execution.

At step 820, an authorization/settlement transaction record is created based on a trigger at step 810. The trigger is preferably when an order confirmation invoice is generated and when the invoice has reached the “Processing Payment” state. When this trigger is activated, the base file is preferably created on a scheduled basis containing just the base elements. A new file is also created when there is a transmission to MS. To this file, records are preferably added as and when payment transactions occur within the EIPP system 120a. At a predetermined time the file is preferably sent to the MS gateway 170a and the process then recommences.

The authorization/settlement transaction is preferably in 810 EDI format and includes Level III settlement data. A unique transaction number, EIPP Generated Match, and Customer Code are also preferably part of this transaction. The data in for authorization/settlement transactions (Level III) are preferably obtained from (a) data elements that are present on the invoice; (b) purchasing card related data; and (c) MS merchant gateway 170a setup information. The authorization/settlement transactions are preferably extracted during regular time intervals and then appended to the batch authorization/settlement file. A backup file is also preferably updated.

At step 830, at predefined time intervals, the authorization/settlement files are sent to the MS gateway 170a through the EIPP system 120a for processing. The MS gateway 170a maps the authorization/settlement file based on the mapping setups that have been defined for the Software Provider 120. The MS gateway 170a identifies the transactions against the appropriate acquired platform. Based on this identification, the authorization/settlement file is split and sent to the corresponding platforms for further processing. The MS gateway 170a could split the authorization/settlement transactions into multiple transactions to accommodate the limitations on the value of the total settlement amount.

At step 840, an authorization response is sent back to the EIPP 120a from the MS Gateway 170a. The responses come back to the EIPP 120a in the 824 EDI format. At step 850, the EIPP 120a receives the authorization response transaction and evaluates the individual response records. Based on the response (failed or otherwise), the system updates the corresponding invoices. In the cases where a successful authorization was possible, the settlement processing is followed through by the MS gateway 170a without any further action required from the Software Provider 120. No responses are expected from the MS gateway 170a for settlement processing.

If the authorization was successful, at step 855 the invoice is flagged as authorized and its state appropriately updated At step 860, the invoice detail is also associated with details of the authorization. This includes authorization code, date of transaction etc. that would be visible to the Supplier/Payees 130. The Buyer/Payer 110 would have visibility only to the date of transaction. Other details of the payment record including the unique transaction number, debit/credit etc. would be also associated with the invoice. At step 865, an e-mail notification is sent to the Supplier/Payee 130 to indicate that the authorization has been successful for the particular invoice. At step 870, an EIPP XML file related transaction is generated for records purposes and is preferably exported as needed.

If the authorization was not successful, at step 875 the invoice is appropriately flagged and the status updated. At step 880, the Buyer/Payer 110 and the Supplier/Payee's 130 agent are appropriately notified through e-mail. Finally, at step 885, transactions are placed in the appropriate failed authorizations exception “basket.”

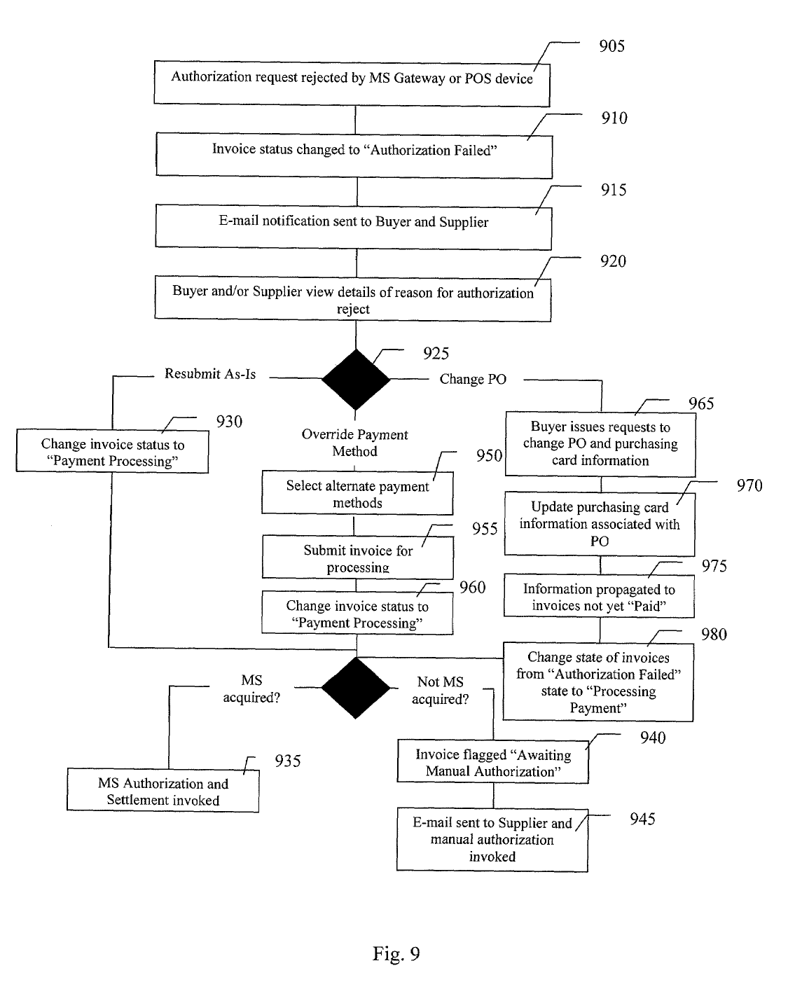

The handling of MS authorization failure will now be described in greater detail in conjunction with FIG. 9, which is a flowchart illustrating an exemplary process of handling MS authorization failure in accordance with the present invention. At step 905, the MS authorization failure process is preferably triggered when an authorization request associated with an invoice or order confirmation has been rejected either by (i) the MS Gateway 170a as part of the MS gateway authorization and settlement process, or (ii) the POS device 310 as part of the manual authorization & settlement process. The data detailing the reasons for the authorization rejection may be obtained either through the MS gateway's 170a authorization response or by manual entry by the agents of Suppliers/Payees 130 that haven not been acquired by the MS gateway 170a. The EIPP system 120a preferably associates the authorization reject reason with the invoice confirmation.

At step 910, the invoice or order confirmation status is changed to “Authorization Failed.” At step 915, an e-mail notification is sent to the Buyer/Payer 110 and to the Supplier/Payee 130 to advise that the payment authorization for the specific invoice or order confirmation has failed. At step 920, both the Buyer/Payer 110 and the Supplier/Payee 130 may choose to view the details of the particular invoice or order confirmation from a “Failed Authorizations” summary view, where the invoice would be flagged as “Authorization failed.” On doing so, the reject reason, which was obtained either through the MS gateway 170a or entered by the Supplier/Payee 130, would be presented to the Buyer/Payer 110 and/or the Supplier/Payee 130 as part of the invoice or order confirmation detail view, as well as additional information explaining the reason and providing guidance for resolving the reject reason.

As part of the detail view of the invoice or order confirmation in the “Authorization Failed” state, the Buyer/Payer 110 is also provided with an option to either “Resubmit As-is” or to “Override Payment Method.” The buyer and supplier may choose to consult each other to assess the possible reasons and remedies for the “Authorization Failure.”

At step 925, the Buyer/Payer 110 may elect to “Resubmit As-Is” the specific invoice or order confirmation for payment processing. This may happen if the reject reason obtained through the EIPP 120a or through external consultations has effected such a direction. At step 930, the invoice or order confirmation status is then changed to “Payment Processing.” If the Supplier/Payee 130 has been acquired by the MS gateway 170a, at step 935 the MS gateway's 170a authorization and settlement procedure is invoked. If the Supplier/Payee 130 has not been acquired by the MS gateway 170a, at step 940, the invoice is flagged “Awaiting Manual Authorization,” and at step 945, an e-mail is sent to the Supplier/Payee 130 to advise that the invoice is awaiting manual authorization, and the manual authorization process is invoked.

At step 925 the Buyer/Payer 110 could elect to override the payment method that has been associated with the original authorization request for the invoice or order confirmation. This may happen if, for example, the reject reason obtained through the EIPP 120a or through external consultations has effected such a direction. If the “Override Payment Method” option is elected, at step 950, the Buyer/Payer 110 is preferably provided with a view to select an alternate payment method or methods. The Buyer/Payer 110 could choose to associate any of the available payment methods, including other purchasing cards. Having selected the payment method, at step 955 the Buyer/Payer 110 may submit the invoice or order confirmation for processing. At step 960, the invoice or order confirmation status is then changed to “Payment Processing.”

If at step 950, the payment method selected was not a purchasing card, the processing would preferably continue in the manner as defined in the “As-Is” system. If the payment method selected was a purchasing card, and if the Supplier/Payee 130 has been acquired by the MS gateway 170a, at step 935 the MS gateway 170a authorization and settlement process may be invoked. If the Supplier/Payee 130 has not been acquired by the MS gateway 170a, at step 940 the invoice is flagged “Awaiting Manual Authorization.” At step 945, an e-mail is sent to the Supplier/Payee 130 to advise that the invoice is awaiting manual authorization, and the manual authorization process is invoked. At step 925, on viewing the invoice or order confirmation rejection details, the Buyer/Payer 110 may elect to change the purchasing card information associated with the invoice through a Change PO transaction. This may happen, for example, if the Buyer/Payer 110 would like to have the change reflected in all the associated invoices or order confirmations, or if no other payment methods are available for the Buyer/Payer 110 to choose from. Preferably, this would only occur if there is a PO that is associated with the invoice within the EIPP 120a.

At step 965, the Buyer/Payer 110 issues a “Change PO” or “Change Purchasing Card information” request. At step 970, the purchasing card information associated with the PO is then updated with the information in the Change PO request. At step 975, the information is propagated to invoices or order confirmations that have generated against the invoice that are not yet in the “Paid” state. At step 980, for those invoices that are in the “Authorization Failed” state, the state is reset to “Processing Payment.” If the Supplier/Payee 130 has been acquired by the MS gateway 170a, at step 935 the MS gateway 170a authorization and settlement process may be invoked. If the Supplier/Payee 130 has not been acquired by the MS gateway 170a, at step 940 the invoice is flagged “Awaiting Manual Authorization.” At step 945, an e-mail is sent to the Supplier/Payee 130 to advise that the invoice is awaiting manual authorization, and the manual authorization process is invoked.

The table below is an example of how the EDI 810 format may be utilized to send authorization and settlement transactions to the MS Gateway.

| | | | | | |
|---|---|---|---|---|---|
| Field | | | | Default/ | |
| Description | Data Type | Length | Req. | Format | Comments |

Header Begin

| | | | | | | |
|---|---|---|---|---|---|---|
| ISA | Interchange | | | | | This is a |
| | Control | | | | | mandatory |
| | Header | | | | | segment |
| ISA01 | Authorization | C | 2 | M | “00” | |
| | Information | | | | | |
| | Qualifier | | | | | |
| ISA02 | Authorization | AN | 10 | M | Spaces | |
| | Information | | | | | |
| ISA03 | Security | C | 2 | M | “00” | |
| | Information | | | | | |
| | Qualifier | | | | | |
| ISA04 | Security | AN | 10 | M | Spaces | |
| | Information | | | | | |
| ISA05 | Interchange | C | 2 | M | | If not |
| | Sender ID | | | | | available will |
| | Qualifier | | | | | be assigned by |
| | | | | | | MS |
| ISA06 | Interchange | AN | 15 | M | | If not |
| | Sender ID | | | | | available will |
| | | | | | | be assigned by |
| | | | | | | MS |
| ISA07 | Interchange | C | 2 | M | 09′ | |
| | Receiver ID | | | | | |
| | Qualifier | | | | | |
| ISA08 | Interchange | AN | 15 | M | “MSSTEST” | |
| | Receiver ID | | | | for test; | |
| | | | | | “MSSPROD” | |
| | | | | | for | |
| | | | | | production; | |
| | | | | | “MSNTEST”; | |
| | | | | | “MSNPROD” | |
| ISA09 | Interchange | DT | 6 | M | YYMMDD | |
| | Date | | | | | |
| ISA10 | Interchange | TM | 4 | M | HHMM | |
| | Time | | | | | |
| ISA11 | Interchange | C | 1 | M | “U” | |
| | Control ID | | | | | |
| ISA12 | Interchange | C | 5 | M | “00410” | |
| | Version | | | | | |
| | Number | | | | | |
| ISA13 | Interchange | N | 9 | M | | Sender |
| | Control | | | | | assigned |
| | Number | | | | | |
| ISA14 | Acknowledgment | C | 1 | M | “1” | |
| | Requested | | | | | |
| ISA15 | Test Indicator | C | 1 | M | “T” for | |
| | | | | | Test; | |
| | | | | | “P” for | |
| | | | | | Production | |
| ISA16 | Sub-element | C | 1 | M | “>” | |
| | Separator | | | | | |
| GS | Functional | | | | | This is a |
| | Group | | | | | mandatory |
| | Header | | | | | segment to |
| | | | | | | indicate the |
| | | | | | | start of a |
| | | | | | | functional |
| | | | | | | group |
| GS01 | Functional | C | 2 | M | “IN” | |
| | Identifier | | | | | |
| | Code | | | | | |
| GS02 | Application | AN | 15 | M | | Sender's ID |
| | Sender's | | | | | |
| | Code | | | | | |
| GS03 | Application | AN | 15 | M | Same as | |
| | Receiver's | | | | ISA08 | |
| | Code | | | | | |
| GS04 | Date | DT | 8 | M | CCYYMMDD | |
| GS05 | Time | TM | 6 | M | HHMM | |
| GS06 | Group | N | 9 | M | | Number |
| | Control | | | | | assigned and |
| | Number | | | | | maintained by |
| | | | | | | sender |
| GS07 | Responsible | C | 2 | M | “X” | |
| | Agency Code | | | | | |
| GS08 | Version/Release/ | AN | 12 | M | “00401” | |
| | Industry | | | | | |
| | Identifier | | | | | |
| | Code | | | | | |

Header Segment - Loop ID - SE Begin

| | | | | | | |
|---|---|---|---|---|---|---|
| ST | Transaction | | | | | Mandatory. |
| | Set Header | | | | | Indicates |
| | | | | | | start of a |
| | | | | | | transaction |
| | | | | | | set |
| ST01 | Transaction | C | 3 | M | “801” - | |
| | Set Identifier | | | | Invoice | |
| | Code | | | | | |
| ST02 | Transaction | AN | 9 | M | starting | Sequential |
| | Set Control | | | | with ‘0001’ | number |
| | Number | | | | | assigned by |
| | | | | | | sender |
| BIG | Beginning | | | | | Mandatory. |
| | Segment for | | | | | |
| | Invoice | | | | | |
| BIG01 | Invoice Issue | DT | 8 | M | CCYYMMDD | |
| | Date | | | | | |
| BIG02 | Invoice | AN | 22 | M | | Maximum 17 |
| | Number | | | | | digits |
| BIG03 | Date | DT | 8 | O | CCYYMMDD | Original PO |
| | | | | | | Date |
| BIG04 | Purchase | AN | 22 | O | | |
| | Order | | | | | |
| | Number | | | | | |
| BG07 | Transaction | C | 2 | M | “DI” - | |
| | Type Code | | | | Debit; | |
| | | | | | “CN” - | |
| | | | | | Credit | |
| BIG09 | Action Code | C | 2 | M | “SE” - | Would be |
| | | | | | Settlement | Typically “7” |
| | | | | | Invoice; | for EIPP |
| | | | | | “7” - | Vendor |
| | | | | | Authorization | |
| | | | | | Invoice | |
| REF | Reference | | | | | |
| | Identification | | | | | |
| REF01 | Reference | C | 3 | M | “E4” - | Charge Card |
| | Identification | | | | | Number |
| | Qualifier | | | | | |
| REF02 | Reference | AN | 30 | X | | Max 16 digits |
| | Identification | | | | | |
| REF03 | Description | | | | | |
| REF | Reference | | | | | This is an |
| | Identification | | | | | optional |
| | | | | | | segment |
| REF01 | Reference | C | 3 | M | “EM” | Electronic |
| | Identification | | | | | Payment |
| | Qualifier | | | | | Reference |
| | | | | | | Number |
| REF02 | Reference | AN | 30 | X | | <MasterCard |
| | Identification | | | | | has to provide |
| | | | | | | what is |
| | | | | | | required> |
| REF03 | Description | | | | | |

Header Segment - Loop ID - SE End
Header Segment - Loop N1 Begin
Buyer Loop Begin

| | | | | | | |
|---|---|---|---|---|---|---|
| N1 | Name | | | | | Buyer Loop |
| N101 | Entity | C | 3 | M | ‘“BY” - | |
| | Identifier | | | | Buyer; | |
| | Code | | | | | |
| N102 | Name | AN | 60 | | | |
| N3 | Address | | | | | |
| | Information | | | | | |
| N301 | Address | AN | 55 | O | | Buying party's |
| | Information | | | | | street address - |
| | | | | | | max 20 |
| | | | | | | digits |
| N4 | Geographic | | | | | |
| | Location | | | | | |
| N401 | City Name | AN | 30 | O | | 13 digits |
| | | | | | | maximum |
| N402 | State or | C | 2 | O | | |
| | Province | | | | | |
| | Code | | | | | |
| N403 | Postal Code | C | 15 | O | No dashes | 9 digits |
| | | | | | allowed | maximum |
| N404 | Country Code | C | 3 | O | | |
| REF | Reference | | | | | |
| REF01 | Reference | C | 3 | M | “CR” | |
| | Identification | | | | | |
| | Qualifier | | | | | |
| REF02 | Reference | AN | 30 | O | | Customer |
| | Identification | | | | | Reference |
| | | | | | | Number |
| | | | | | | (Could be the |
| | | | | | | PO# or some |
| | | | | | | other GL |
| | | | | | | based number) |
| | | | | | | would be |
| | | | | | | decided at |
| | | | | | | time of |
| | | | | | | customer |
| | | | | | | implementation |

Buyer Loop End
Seller Loop Begin

| | | | | | | |
|---|---|---|---|---|---|---|
| N1 | Name | | | | | Seller Loop |
| N101 | Entity | C | 3 | M | “SE” - | |
| | Identifier | | | | Seller; | |
| | Code | | | | | |
| N102 | Name | AN | 60 | | | |
| REF | Reference | | | | | |
| REF01 | Reference | C | 3 | M | “VR” | |
| | Identification | | | | | |
| | Qualifier | | | | | |
| REF02 | Reference | AN | 30 | O | | MS Assigned |
| | Identification | | | | | Merchant |
| | | | | | | Number |
| REF | Reference | | | | | |
| REF01 | Reference | C | 3 | M | “CA” | |
| | Identification | | | | | |
| | Qualifier | | | | | |
| REF02 | Reference | AN | 30 | O | | Unique |
| | Identification | | | | | Number |
| REF | Reference | | | | | |
| REF01 | Reference | C | 3 | M | “TJ” | |
| | Identification | | | | | |
| | Qualifier | | | | | |
| REF02 | Reference | AN | 30 | O | | Seller Federal |
| | Identification | | | | | Tax ID |
| REF | Reference | | | | | |
| REF01 | Reference | C | 3 | M | “ZA” | |
| | Identification | | | | | |
| | Qualifier | | | | | |
| REF02 | Reference | AN | 30 | O | 1000 | Merchant |
| | Identification | | | | | Type Code. If |
| | | | | | | no valuable |
| | | | | | | information |
| | | | | | | can be |
| | | | | | | provided then |
| | | | | | | the value |
| | | | | | | ‘1000’ would |
| | | | | | | be provided. |

Seller Loop End
Header Segment - Loop N1 End

| | | | | | | |
|---|---|---|---|---|---|---|
| DTM | Date/Time | | | | | |
| | Reference | | | | | |
| DTM01 | Date/Time | C | 3 | M | “036” | To indicate |
| | Qualifier | | | | | that the value |
| | | | | | | of DTM06 |
| | | | | | | would |
| | | | | | | be Credit Card |
| | | | | | | expiration |
| | | | | | | date |
| DTM05 | Date Time | C | 3 | M | “YM” | |
| | Period | | | | | |
| | Format | | | | | |
| | Qualifier | | | | | |
| DT02 | Date Time | AN | 35 | M | YYMM | Credit Card |
| | Period | | | | | Expiration |
| | | | | | | Date |

Header End
Detail Begin
Detail Segment - Loop ID - IT1 Begin

| | | | | | | |
|---|---|---|---|---|---|---|
| IT1 | Baseline | | | | | Multiple |
| | Item Data | | | | | records in |
| | | | | | | this segment |
| | | | | | | due to |
| | | | | | | multiple line |
| | | | | | | items |
| IT102 | Quantity | N | 10 | X | | |
| | Invoiced | | | | | |
| IT103 | Unit of | C | 2 | X | “EA” - | |
| | Measurement | | | | Each | |
| | Code | | | | | |
| IT104 | Unit Price | N | 17 | X | Includes | |
| | | | | | decimals | |
| IT108 | Product/Service | C | 2 | X | “PN” - | |
| | ID | | | | Company | |
| | Qualifier | | | | Product | |
| | | | | | No.; “MG” - | |
| | | | | | Manufacturer's | |
| | | | | | part no. | |
| IT109 | Product/Service | AN | 48 | X | | 12 digits |
| | ID | | | | | maximum, |
| | | | | | | Could be |
| | | | | | | default to |
| | | | | | | “99999” if no |
| | | | | | | value is |
| | | | | | | available |
| TX1 | Tax | | | | | This segment |
| | Information | | | | | is optional |
| | | | | | | and would |
| | | | | | | not be used |
| | | | | | | for the |
| | | | | | | MasterCard |
| | | | | | | Project (until |
| | | | | | | Buyer/Payer |
| | | | | | | specific |
| | | | | | | requirements |
| | | | | | | are provided) |
| TX101 | Tax Type | C | 2 | M | “VA” - | |
| | Code | | | | Value | |
| | | | | | Added Tax | |
| TX102 | Monetary | N | 18 | X | | |
| | Amount | | | | | |
| TX103 | Percent | N | 10 | X | | |

PID Loop Begin

| | | | | | | |
|---|---|---|---|---|---|---|
| PID | Product Item | | | | | |
| | Description | | | | | |
| PID01 | Item | C | 1 | M | “F”- Free | |
| | Description | | | | form | |
| | Type | | | | description | |
| PID05 | Description | AN | 35 | X | | Max 35 digits |
| | | | | | | for |
| | | | | | | MasterCard |

PID Loop End
SAC Loop Begin

| | | | | | |
|---|---|---|---|---|---|
| SAC | Service, | | | | Since |
| | Promotion, | | | | discount |
| | Allowance, | | | | processing is |
| | or Charge | | | | not pat of the |
| | Information | | | | requirements |
| | | | | | this segment |
| | | | | | would not be |
| | | | | | used. |
| SAC01 | Allowance or | C | 1 | “A” - | |
| | Charge | | | Allowance; | |
| | Indicator | | | “C” - | |
| | | | | Charge | |
| SAC02 | Service, | C | 4 | “C310” - | |
| | Promotion, | | | Discount; | |
| | Allowance, or | | | “D240”- | |
| | Charge Code | | | Freight; | |
| | | | | “D500”- | |
| | | | | Handling | |
| SAC03 | Agency | C | 2 | | |
| | Qualifier | | | | |
| | Code | | | | |
| SAC04 | Agency | AN | 10 | | |
| | Service, | | | | |
| | Promotion, | | | | |
| | Allowance, or | | | | |
| | Charge Code | | | | |
| SAC05 | Amount | N | 15 | 2 decimals | |
| SAC06 | Allowance/C | C | 1 | | |
| | harge Percent | | | | |
| | Qualifier | | | | |
| SAC07 | Percent | N | 6 | | |

SAC Loop End
Detail Segment - Loop ID - IT1 End
Detail End
Summary Begin

| | | | | | | |
|---|---|---|---|---|---|---|
| TDS | Total | | | | | |
| | Monetary | | | | | |
| | Value | | | | | |
| | Summary | | | | | |
| TDS01 | Amount | N | 15 | M | | Total amount |
| | | | | | | of the invoice, |
| | | | | | | including |
| | | | | | | taxes, freight |
| | | | | | | and less |
| | | | | | | discounts |
| TXI | Tax | | | | | Optional |
| | Information | | | | | |
| TXI01 | Tax Type | C | 2 | M | “TX” - All | |
| | Code | | | | Taxes | |
| | | | | | “VA” - | |
| | | | | | Value | |
| | | | | | Added Tax | |
| | | | | | “OH” - | |
| | | | | | Other | |
| | | | | | Taxes | |
| TXI02 | Monetary | R | 18 | X | | Tax amount |
| | Amount | | | | | corresponding |
| | | | | | | to TXI01. |
| | | | | | | (Use |
| | | | | | | Decimals) |
| CTT | Transaction | | | | | Optional |
| | Totals | | | | | |
| CTT01 | Number of | N | 6 | M | | Total number |
| | Line Items | | | | | of line items |
| | | | | | | in the |
| | | | | | | transaction set |

Summary End

| | | | | | |
|---|---|---|---|---|---|
| SE | Transaction | | | | This segment |
| | Set Trailer | | | | is mandatory. |
| SE01 | Number of | N | 10 | M | Total number |
| | included | | | | of segments in |
| | segments | | | | the transaction |
| | | | | | set including |
| | | | | | ST and SE |
| | | | | | segments |
| SE02 | Transaction | AN | 9 | M | Must be same |
| | Set Control | | | | as ST02 |
| | Number | | | | |
| GE | Functional | | | | This segment |
| | Group | | | | is mandatory. |
| | Trailer | | | | |
| GE01 | Number of | N | 6 | M | |
| | Transaction | | | | |
| | Sets Included | | | | |
| GE02 | Transaction | N | 9 | M | Must be same |
| | Set Control | | | | as GS06 |
| | Number | | | | |
| IEA | Interchange | | | | This segment |
| | Control | | | | is mandatory. |
| | Trailer | | | | |
| IEA01 | Number of | N | 5 | M | Total number |
| | Included | | | | of functional |
| | Functional | | | | groups in the |
| | Groups | | | | interchange |
| IEA02 | Interchange | N | 9 | M | Must be same |
| | Control | | | | as ISA13 |
| | Number | | | | |

M—Mandatory
X - Conditional
O—Optional

The table below provides an example of how the EDI 824 format may be utilized by the MS gateway 170a to send authorization responses back to the Software Provider 170. In this example, EDI 997 would be sent by the MS gateway 170a to acknowledge whether the format of the request was proper.

| | | Data | | | Default/ | |
|---|---|---|---|---|---|---|
| | Field Description | Type | Length | Req. | Format | Comments |
| ISA | Interchange | | | | | This is a |
| | Control Header | | | | | mandatory |
| | | | | | | segment |
| ISA01 | Authorization | C | 2 | M | “00” | |
| | Information | | | | | |
| | Qualifier | | | | | |
| ISA02 | Authorization | AN | 10 | M | Spaces | |
| | Information | | | | | |
| ISA03 | Security | C | 2 | M | “00” | |
| | Information | | | | | |
| | Qualifier | | | | | |
| ISA04 | Security | AN | 10 | M | Spaces | |
| | Information | | | | | |
| ISA05 | Interchange | C | 2 | M | “09” | |
| | Sender ID | | | | | |
| | Qualifier | | | | | |
| ISA06 | Interchange | AN | 15 | M | “MSSTEST” | |
| | Sender ID | | | | for test; | |
| | | | | | “MSSPROD” | |
| | | | | | for | |
| | | | | | production; | |
| | | | | | “MSNTEST”; | |
| | | | | | “MSNPROD” | |
| ISA07 | Interchange | C | 2 | M | | If not |
| | Receiver ID | | | | | available will |
| | Qualifier | | | | | be assigned by |
| | | | | | | MS |
| ISA08 | Interchange | AN | 15 | M | | If not |
| | Receiver ID | | | | | available will |
| | | | | | | be assigned by |
| | | | | | | MS |
| ISA09 | Interchange Date | DT | 6 | M | YYMMDD | |
| ISA10 | Interchange Time | TM | 4 | M | HHMM | |
| ISA11 | Interchange | C | 1 | M | “U” | |
| | Control ID | | | | | |
| ISA12 | Interchange | C | 5 | M | “00401” | |
| | Version Number | | | | | |
| ISA13 | Interchange | N | 9 | M | | Sender |
| | Control Number | | | | | assigned |
| ISA14 | Acknowledgment | C | 1 | M | “0” | |
| | Requested | | | | | |
| ISA15 | Test Indicator | C | 1 | M | “T” for | Must |
| | | | | | Test; | correspond to |
| | | | | | “P” for | ISA06 |
| | | | | | Production | |
| ISA16 | Sub-element | C | 1 | M | “\” | |
| | Separator | | | | | |
| GS | Functional | | | | | This is a |
| | Group Header | | | | | mandatory |
| | | | | | | segment to |
| | | | | | | indicate the |
| | | | | | | start of a |
| | | | | | | functional |
| | | | | | | group |
| GS01 | Functional | C | 2 | M | “AG” | |
| | Identifier Code | | | | | |
| GS02 | Application | AN | 15 | M | Same as | |
| | Sender's Code | | | | ISA06 | |
| GS03 | Application | AN | 15 | M | | Receiver ID |
| | Receiver's Code | | | | | |
| GS04 | Date | DT | 8 | M | CCYYMMDD | |
| GS05 | Time | TM | 6 | M | HHMM | |
| GS06 | Group Control | N | 9 | M | | Number |
| | Number | | | | | assigned and |
| | | | | | | maintained by |
| | | | | | | sender |
| GS07 | Responsible | C | 2 | M | “X” | |
| | Agency Code | | | | | |
| GS08 | Version/Release/Industry | AN | 12 | M | “004010” | |
| | Identifier | | | | | |
| | Code | | | | | |
| ST | Transaction Set | | | | | Mandatory. |
| | Header | | | | | Indicates |
| | | | | | | start of a |
| | | | | | | transaction |
| | | | | | | set |
| ST01 | Transaction Set | C | 3 | M | “824” - | |
| | Identifier Code | | | | Application | |
| | | | | | Advice | |
| ST02 | Transaction Set | AN | 9 | M | | Sequential |
| | Control Number | | | | | number |
| | | | | | | assigned by |
| | | | | | | sender |

Header Begin

| | | | | | | |
|---|---|---|---|---|---|---|
| BGN | Beginning | | | | | Mandatory. |
| | Segment | | | | | |
| BGN01 | Transaction Set | C | 2 | M | “00” - | |
| | Purpose Code | | | | Original | |
| BGN02 | Reference | AN | 30 | M | | Trace number |
| | Identification | | | | | |
| BGN03 | Date | DT | 8 | M | CCYYMMDD | File creation |
| | | | | | | date |

Header End
Detail Begin
Detail Segment Loop ID - OT1 Begin

| | | | | | | |
|---|---|---|---|---|---|---|
| OTI | Original | | | | | Mandatory |
| | Transaction | | | | | |
| | Identification | | | | | |
| OTI01 | Application | C | 2 | M | “TA” - | TA - if Detail |
| | Acknowledgment | | | | Transaction | Record |
| | Code | | | | Set Accept; | Authorization |
| | | | | | “TR” | field = 6 |
| | | | | | Transaction | chars; TR if |
| | | | | | Set Reject | the field = 4 |
| | | | | | | chars |
| OTI02 | Reference | C | 3 | M | “IV” - | |
| | Identification | | | | Seller's | |
| | Qualifier | | | | Invoice | |
| | | | | | Number | |
| OTI03 | Reference | AN | 30 | M | | Invoice |
| | Identification | | | | | number |
| REF | Reference | | | | | This is an |
| | Identification | | | | | optional |
| | | | | | | segment. |
| | | | | | | Loops with |
| | | | | | | OTI. It is |
| | | | | | | mapped only |
| | | | | | | if OTI01 = |
| | | | | | | “TA” |
| REF01 | Reference | C | 3 | M | “BB” - | |
| | Identification | | | | Authorization | |
| | Qualifier | | | | Number | |
| REF02 | Reference | AN | 30 | X | | Authorization |
| | Identification | | | | | Number |
| REF03 | Description | AN | 80 | X | | CVV2_Indicator, |
| | | | | | | CVV2_Value, |
| | | | | | | CVV2_Result |
| | | | | | | if present. |
| AMT | Monetary | | | | | This segment |
| | Amount | | | | | is optional. |
| | | | | | | Loops with |
| | | | | | | OTI |
| AMT01 | Amount Qualifier | C | 3 | M | | |
| | Code | | | | | |
| AMT02 | Monetary Amount | N | 18 | M | | Total Amount |
| | | | | | | of invoice |

Detail Segment Loop ID - OT1 End
Detail Segment Loop ID - TED Begin

| | | | | | | |
|---|---|---|---|---|---|---|
| TED | Technical | | | | | This is an |
| | Error | | | | | Optional |
| | Description | | | | | segment |
| TED01 | Application Error | C | 3 | M | “024” - | Buying party's |
| | Condition Code | | | | Other | street address - |
| | | | | | unlisted | max 20 |
| | | | | | Reason | digits |
| TED02 | Free Form | AN | 60 | O | | Decline |
| | Message | | | | | Reason Code, |
| | | | | | | followed by |
| | | | | | | space and then |
| | | | | | | the matching |
| TED03 | Copy of Bad Data | AN | 99 | O | | Product Code |
| | Element | | | | | followed by |
| | | | | | | space and then |
| | | | | | | “X”s for |
| | | | | | | Cardholder |
| | | | | | | Number |
| | | | | | | except last |
| | | | | | | four (4) digits |
| | | | | | | which will |
| | | | | | | appear here. |
| NTE | Note/Special | | | | | Optional. |
| | Instruction | | | | | Loop with |
| | | | | | | TED |
| NTE01 | Note Reference | C | 3 | O | “TRS” - | |
| | Code | | | | Quality | |
| | | | | | Information | |
| NTE02 | Description | AN | 80 | M | | From |
| | | | | | | MSFTEST or |
| | | | | | | MSFPROD if |
| | | | | | | Fraud Score is |
| | | | | | | present |
| RED | Related Data | | | | | Optional. |
| | | | | | | Loop with |
| | | | | | | TED |
| REF01 | Description | AN | 80 | M | MasterCard | |
| | | | | | Advice | |
| REF02 | Related Data | C | 3 | X | “AI” - | |
| | Identification | | | | Assigned | |
| | Code | | | | Identification | |

Detail Segment Loop ID - TED End
Detail End

| | | | | | |
|---|---|---|---|---|---|
| SE | Transaction Set | | | | This segment |
| | Trailer | | | | is mandatory. |
| SE01 | Number of | N | 10 | M | Total number |
| | included segments | | | | of segments in |
| | | | | | the transaction |
| | | | | | set including |
| | | | | | ST and SE |
| | | | | | segments |
| SE02 | Transaction Set | AN | 9 | M | Must be same |
| | Control Number | | | | as ST02 |
| GE | Functional | | | | This segment |
| | Group Trailer | | | | is mandatory. |
| GE01 | Number of | N | 6 | M | |
| | Transactions Sets | | | | |
| | Included | | | | |
| GE02 | Transaction Set | N | 9 | M | Must be same |
| | Control Number | | | | as GS06 |
| IEA | Interchange | | | | This segment |
| | Control Trailer | | | | is mandatory. |
| IEA01 | Number of | N | 5 | M | Total number |
| | Included | | | | of functional |
| | Functional | | | | groups in the |
| | Groups | | | | interchange |
| IEA02 | Interchange | N | 9 | M | Must be same |
| | Control Number | | | | as ISA13 |

The following table outlines exemplary MS gateway 170a response/reason codes, in accordance with the present invention. In the following table, “**” denotes an MS gateway 170a generated response.

MS Response Codes/Reason Codes

| | | REASON | |
|---|---|---|---|
| RESPONSE CODE | | CODE | |
| 1. | ND - DECLINE | | |
| 2. | DO NOT HONOR | 3. | 01 |
| 4. | INSUFFICIENT FUNDS | 5. | 02 |
| 6. | TRANSACTION NOT PERMITTED | 7. | 03 |
| 8. | EXCEEDS WITHDRAWAL AMOUNT | 9. | 07 |
| 10. | EXCEEDS WITHDRAWAL COUNT | 11. | 08 |
| 12. | NON-EXISTENT ACCOUNT | 13. | 09 |
| 14. | NC & F1 - PICKUPS | | |
| 15. | PICKUP | 16. | 01 |
| 17. | LOST CARD | 18. | 02 |
| 19. | STOLEN CARD | 20. | 03 |
| 21. | PICKUP SPECIAL | 22. | 04 |
| 23. | NR - REFERRAL | | |
| 24. | **TIMEOUT | 25. | 01 |
| 26. | REFER TO ISSUER | 27. | 02 |
| 28. | SYSTEM INOPERATIVE | 29. | 03 |
| 30. | INVALID TRANSACTION | 31. | 04 |
| 32. | INVALID AMOUNT | 33. | 05 |
| 34. | INVALID CARD NUMBER | 35. | 06 |
| 36. | INVALID ISSUER | 37. | 07 |
| 38. | INVALID MERCHANT | 39. | 08 |
| 40. | EXPIRED CARD | 41. | 09 |
| 42. | RESTRICTED CARD | 43. | 11 |
| 44. | SYSTEM ERROR | 45. | 12 |
| 46. | CANNOT ROUTE TRANSACTION | 47. | 19 |
| 48. | FORMAT ERROR | 49. | 20 |
| 50. | DUPLICATE TRANSACTION | 51. | 21 |
| 52. | NS - INVALID | | |
| 53. | **BAD TRANSACTION DATE | 54. | 01 |
| 55. | **BAD AMOUNT | 56. | 02 |
| 57. | **TRANSACTION AMOUNT | 58. | 03 |
| | EQUALS ZERO | | |
| 59 | **INVALID ACCOUNT NUMBER | 60. | 04 |
| | LENGTH | | |
| 61. | **BAD CARD TYPE CODE | 62. | 05 |
| 63. | **BAD CHECK DIGIT VALUE | 64. | 06 |
| 65. | **INVALID CVC2 CODE | 66. | 07 |
| 67. | **UNRECOGNIZED RESPONSE | 68. | 10 |
| 69. | **NON-NUMERIC ACCOUNT | 70. | 11 |
| | NUMBER | | |
| 71. | **INVALID EXPIRATION DATE | 72. | 12 |
| 73. | **UNRECOGNIZED TRANSACTION | 74. | 14 |
| 75. | **INVALID BIN/PREFIX | 76. | 15 |
| 77. | **MERCHANT NOT IN | 78. | 16 |
| | CANCLLEATION PROGRAM | | |
| 79. | **INVALID EC INDICATOR | 80. | 17 |
| 81. | **INVALID MERCHANT | 82. | 18 |
| | TRANSACTION INDICATOR | | |
| 83. | **SE NUMBER NOT FOUND | 84. | 19 |
| 85. | NE - EXPIRED CARDS | | |
| 86. | **EXPIRED CARD | 87. | 01 |
| 88. | NZ - SOFT DECLINE REAUTHORIZATION | | |
| 89. | **INITIAL SOFT DECLINE | 90. | 00 |
| | CAPTURED FOR REAUTHOIRZATION | | |
| 91. | **1^{ST} TIME TRANSACTION | 92. | 01 |
| | RECYCLED | | |
| 93. | **2^{ND} TIME TRANSACTION | 94. | 02 |
| | RECYCLED | | |
| 95. | **3^{RD} TIME TRANSACTION | 96. | 03 |
| | RECYCLED | | |
| 97. | **4^{TH} TIME TRANSACTION | 98. | 04 |
| | RECYCLED | | |
| 99. | **5^{TH} TIME TRANSACTION | 100. | 05 |
| | RECYCLED | | |
| 101. | **6^{TH} TIME TRANSACTION | 102. | 06 |
| | RECYCLED | | |
| 103. | **7^{TH} TIME TRANSACTION | 104. | 07 |
| | RECYCLED | | |
| 105. | **8^{TH} TIME TRANSACTION | 106. | 08 |
| | RECYCLED | | |
| 107. | **9^{TH} TIME TRANSACTION | 108. | 09 |
| | RECYCLED | | |

Although the present invention has been described with reference to certain preferred embodiments, various modifications, alterations, and substitutions will be known or obvious to those skilled in the art without departing from the spirit and scope of the invention, as defined by the appended claims.

We claim:

1. A method for conducting a purchasing card transaction between a buyer and supplier by way of an electronic bill payment and presentment (EIPP) system, the method comprising:
approving an invoice for the purchasing card transaction in the buyer's enterprise resource planning (“ERP”) system;
scheduling the invoice for payment in the buyer's ERP system;
extracting from the buyer's ERP system a payment file that includes a unique transaction identifier associated with the transaction;
submitting data describing the transaction, including the unique transactions identifier, to a point-of-sale (POS) device for authorization and settlement;
sending line item detail data describing the transaction, the line item data including the unique transaction identifier, from the EIPP system to a purchasing card payment network for matching;
providing to the buyer's ERP a purchasing card statement including data describing the transaction, the statement data including the unique transaction identifier; and
settling, by the buyer, the transaction with a purchasing card issuer.

2. The method according to claim 1, further comprising:
providing remittance data from an acquirer to the supplier, the remittance data including the unique transaction identifier, for reconciling the supplier's accounts.
